(19) United States
(12) Patent Application Publication
(10) Pub. No.: US 2010/0298022 A1
(43) Pub. Date: Nov. 25, 2010

(54) CONFIGURATION OF RADIO COVERAGE

(75) Inventors: Fatima Karim, Paris (FR); Sana Ben Jemaa, Issy Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, PARIS (FR)

(21) Appl. No.: 12/681,915

(22) PCT Filed: Oct. 17, 2008
(86) PCT No.: PCT/FR08/51882

§ 371 Date: May 26, 2010

(30) Foreign Application Priority Data
Oct. 26, 2007 (FR) 0707554

(51) Int. Cl. H04B 7/00

(52) U.S. Cl. 455/522

(57) ABSTRACT

A cellular radio communications network includes a plurality of radio cells. A target radio coverage is associated with each radio cell. Each operational radio cell provides an effective radio coverage defined by a transmission power value of said radio cell. A given transmission power value is applied (21) to a particular set of radio cells. A radio cell is then selected (22). Thereafter, cellular information is obtained (23) relating to a group of radio cells comprising the selected radio cell and neighboring cells. On the basis of the cellular information, the effective radio coverages of the cells of said group and the respective target radio coverages of the cells of said group are compared (24). If the effective radio coverage of at least one cell of the group of radio cells is less than its target radio coverage (25), respective new transmission power values are applied (26) to radio cells of said group of cells. Certain steps are then repeated, as appropriate.

The present invention relates to radio telecommunications networks and more particularly to planning and optimizing radio coverage in such networks.

Each of the radio cells constituting a cellular telecommunications network provides radio coverage of a target geographical area. The combined radio coverages of all the cells define the overall coverage of the cellular network concerned.

It is important for this overall radio coverage to conform to certain constraints.

A first constraint is to offer effective overall radio coverage, i.e. the radio coverage that is actually provided by the network, that corresponds to a target radio coverage, i.e. to coverage of a predefined geographical area or space.

A second constraint is to avoid the occurrence of interference caused by overlapping cellular radio coverages. If the overlap between two radio coverages is too pronounced or if the cell density is high at a particular place, interference may be produced that may lead to a reduction in the level of quality of calls managed in the network.

The quality of service of calls managed in networks of this type therefore depends in particular on achieving a compromise between these two constraints, i.e. a constraint relating to radio coverage and a constraint relating to radio interference.

It is not easy to determine a radio coverage configuration based on such a compromise since many parameters must be taken into account. Furthermore, as soon as the architecture of the cellular network concerned is modified, it is necessary to determine a new radio coverage configuration depending on a new compromise between the above constraints.

Such configuration is required when installing the network and whenever a new cell is introduced into an existing network. This kind of radio coverage configuration stage is referred to as a radio coverage planning stage.

Such planning is generally based on planning tools that are independent of the architecture of the network concerned and is determined long before the installation of the network takes place. Once the planning parameters have been determined using such planning tools, human manual intervention is then required to set the new parameters.

Moreover, it may be necessary to reconfigure radio coverage in order to improve the level of quality of such a network that is already in operation. This is achieved as described above for the planning stage. This kind of stage is referred to as a radio coverage optimization stage.

The present invention aims to improve on this situation.

A first aspect of the present invention proposes a method of configuring radio coverage in a cellular radio communications network including a plurality of radio cells, a target radio coverage being associated with each radio cell, and each operational radio cell providing an effective radio coverage defined by a transmission power value of said radio cell, said method including the following steps:

a) applying (21) a given transmission power value to a particular set consisting of at least one radio cell from the plurality of radio cells;

b) selecting (22) a radio cell from said particular set of radio cells;

c) obtaining (23) cellular information relating to a group of radio cells comprising the selected radio cell and neighboring cells;

d) on the basis of the cellular information, comparing (24) the effective radio coverages of the cells of said group and the respective target radio coverages of the cells of said group; and

e) if the effective radio coverage of at least one radio cell of said group of radio cells is less than the target radio coverage of said at least one radio cell (25) of the group:
applying (26) respective new transmission power values to the radio cells of said group of cells; and
repeating steps c) to e).

The expression ‘neighboring radio cells’ as applied to a given radio cell refers to radio cells with radio coverage that geographically adjoins the geographical area covered by the given radio cell.

The expression ‘effective radio coverage’ refers to the radio coverage that is actually provided by an operational radio cell, i.e. a radio cell that is in a position to manage a call.

The expression ‘target radio coverage’ refers to the radio coverage that is theoretically associated with a radio cell, i.e. the geographical space to be covered by that cell.

The given transmission power used in the step a) may be a network configuration parameter.

By means of such provisions, it is possible to configure the radio coverage of a communications network automatically.

By proceeding in this way, the radio coverage of cells of the network for which the transmission power is suitable is not modified. Because of this, the signaling load in the network linked to this method may be optimized.

Such automatic configuration of the radio coverage may be used both in the context of planning and in the context of optimizing radio coverage.

Thus human manual intervention to configure the radio coverage of a cellular network is no longer required, neither when the network is installed nor when introducing a new cell into the network. In one implementation of the present invention, it is indeed possible to effect this configuration automatically.

Furthermore, in relation to optimizing radio coverage, the potential problem of interference between cells may advantageously be solved dynamically and automatically without requiring human intervention.

Such features make it possible to improve the quality of service offered in such a network at the same time as limiting the cost associated with managing the configuration of the radio coverage of such a network.

The new transmission power values may be determined by comparing the effective radio coverages and the respective target radio coverages of the cells of the group of radio cells by analyzing the quality indicators of those radio cells.

The set consisting of at least one radio cell is a set including at least one new radio cell introduced into the network or at least one radio cell of the network suffering a network problem. Thus in one implementation of the present invention, the radio coverage may be configured when a new radio cell is installed or to optimize the radio coverage in the event of network problems.

If the effective radio coverage of the selected radio cell is less than (or greater than), the target radio coverage of the selected radio cell, then the transmission power value of the selected radio cell may advantageously be increased (or decreased), and/or if the effective radio coverage of at least one neighboring radio cell of the selected radio cell is less than (or greater than), the target radio coverage of said at least one neighboring radio cell, then the transmission power value of said at least one neighboring radio cell may advantageously be increased (or decreased).

The steps of the method may be triggered periodically, on detection of a network problem, or on introducing at least one new radio cell into the network.

Network problems may include a cut-off rate above a cut-off rate threshold value, a quality of service level below a quality of service level threshold value, and data traffic below a traffic threshold value.

The steps b) to e) are applied to each radio cell of the set consisting of at least one radio cell. Thus, if configuring the radio coverage relates to a plurality of radio cells, they are taken into account successively. Cells within this set of cells may be selected in an order that is defined or arbitrary.

The cellular information for a radio cell may relate to a temporal signature of a radio cell, a spatial signature of a radio cell, and a list of neighboring radio cells of said radio cell.

A spatial signature corresponds to information characterizing the dimensions of the target radio coverage of the radio cell concerned. This information may consist in particular of path loss values. Note that to obtain good effective radio coverage it is desirable to use path loss samples in a balanced spatial distribution over the target coverage area of a given radio cell.

A temporal signature corresponds to information used to characterize a behavior of the radio cell over a time period and the geographical surroundings of its effective radio coverage. Such a temporal signature may correspond to a set of statistics based on the evolution of certain metrics obtained periodically or triggered by an event. Such a metric may correspond to:
information relating to an absolute RSCP (received signal code power) value of a signal received by a terminal managed in the radio cell concerned;
information relating to a signal-to-noise ratio (Ec/No) value, which is a ratio between an energy value per modulated bit and a spectral density value of the total noise received at a terminal in the radio cell concerned;
a cell load indicator;
a cell traffic indicator;
a call cut-off rate in the cell;
an interference level;
a call admission rate; and/or
a number of call transfers between cells (handovers).

A second aspect of the present invention provides a radio coverage configuration entity adapted to execute the steps of a radio coverage configuration method of the first aspect of the present invention.

A third aspect of the present invention provides a computer program adapted to be installed in a configuration entity of the second aspect of the present invention and including instructions for executing the method of the first aspect of the present invention when the program is executed by processing means of the configuration entity.

A fourth aspect of the present invention provides a computer-readable storage medium storing the computer program of the third aspect of the present invention.

Other aspects, objects and advantages of the invention become apparent on reading the description of one implementation of the invention.

The invention may also be better understood with the assistance of the drawings, in which:

FIG. 1 shows a telecommunications network architecture of one implementation of the present invention;

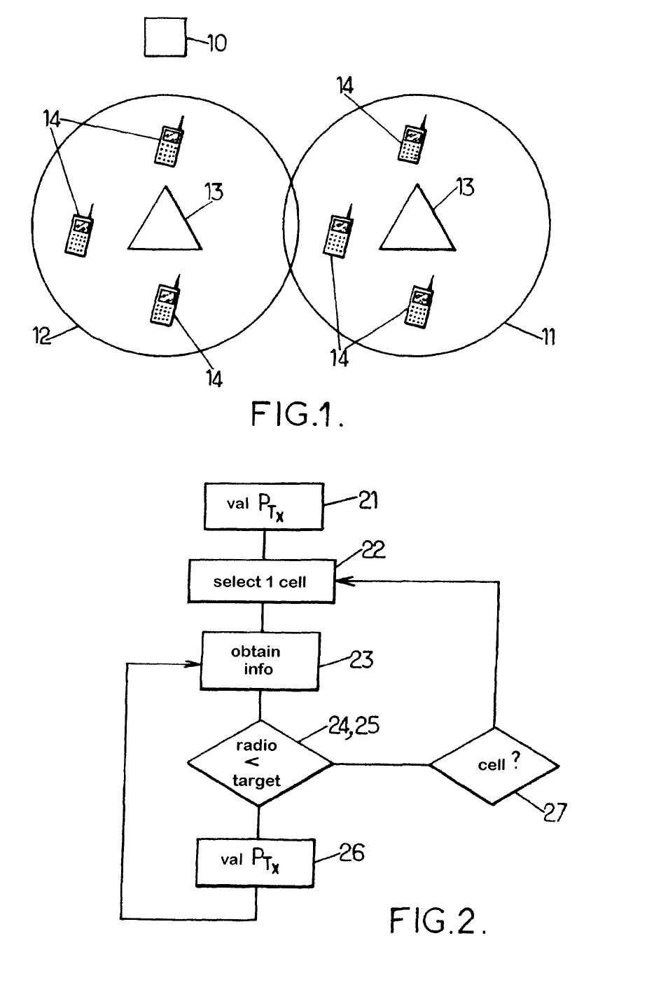

FIG. 2 shows the main steps of a radio coverage configuration method of one implementation of the present invention;

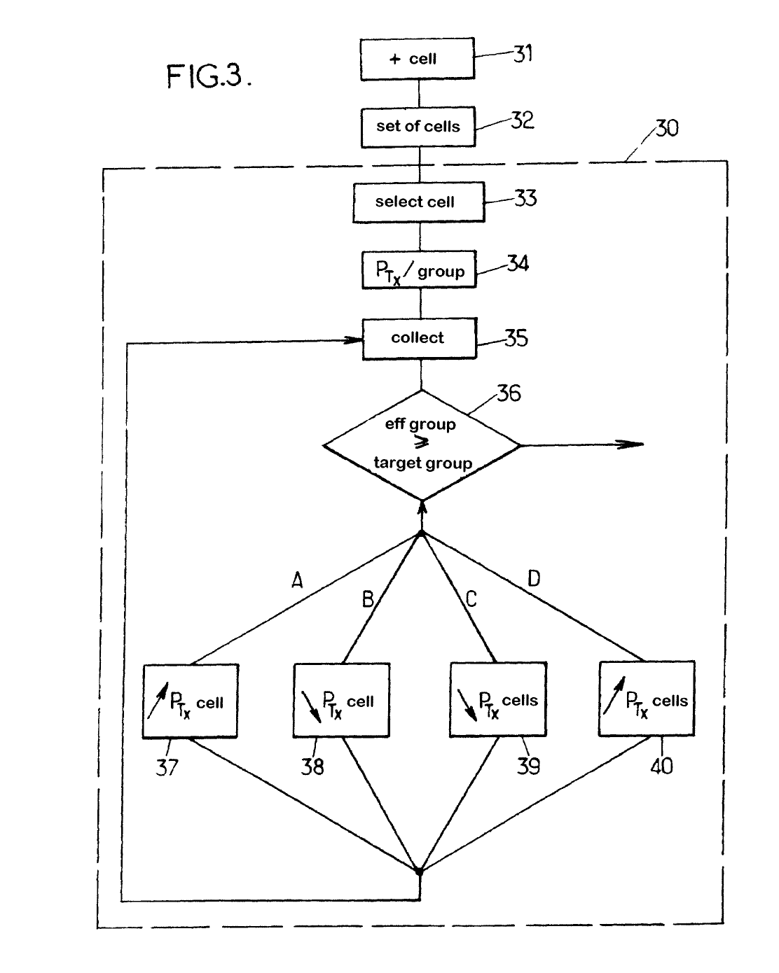

FIG. 3 shows a network radio coverage planning method of one implementation of the present invention;

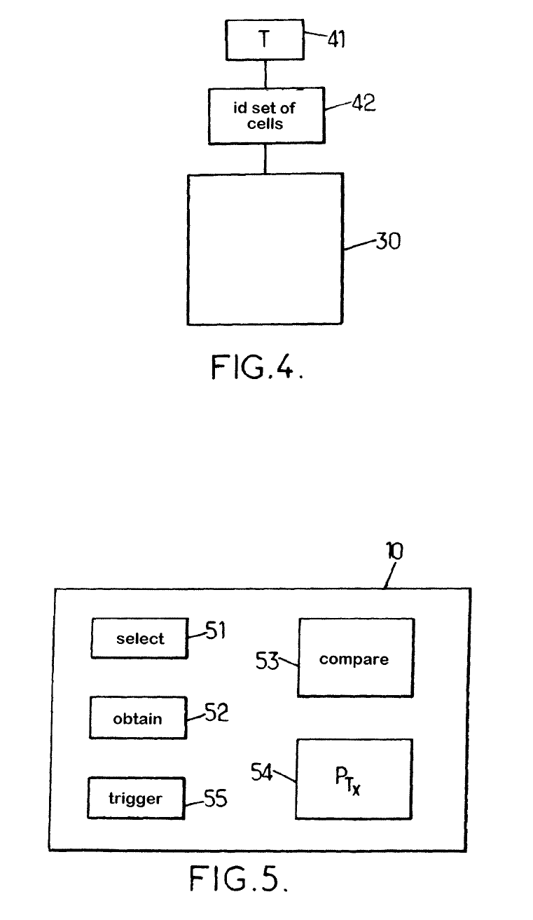

FIG. 4 shows a network radio coverage optimization method of one implementation of the present invention; and

FIG. 5 shows a radio coverage configuration entity of one implementation of the present invention.

FIG. 1 shows a telecommunications network architecture of one implementation of the present invention. Such a network includes base stations 13 and mobile terminals 14. A base station may be responsible for the management of one or more cells of the network. The present invention is not limited in any way with regard to this aspect. For example, each radio cell is managed here by a base station. Radio coverages 11 and 12 are associated with respective base stations 13.

Such a network further includes a radio coverage configuration entity 10 adapted to execute one implementation of the radio coverage configuration method of the present invention dynamically and automatically.

The present invention is not limited in any way with regard to the location of this configuration entity 10 in the network. For example, in a mobile communications network, this configuration entity may be located at an operation and maintenance center (OMC) or a radio network controller (RNC).

This configuration entity 10 determines a common channel transmission power value for a new radio cell that is being commissioned, i.e. that is in the process of becoming an operational radio cell.

FIG. 2 shows the main steps of a radio coverage configuration method of one implementation of the present invention.

In a step 21, it is decided to apply a given transmission power to a set of radio cells of the network consisting of at least one such cell. This transmission power may be a transmission power value predefined in the configuration entity as a default transmission power value. This value, being a network configuration parameter, may advantageously be defined as a function of the architecture of the network concerned.

Furthermore, the set consisting of at least one radio cell may be determined as a function of the context in which the radio coverage configuration method is triggered. If the method is triggered by introducing a new radio cell into the network, then the set of radio cell(s) contains that new radio cell. If several radio cells are introduced at the same time, then the set of radio cells contains all those new radio cells.

In a different situation, in which the configuration process is triggered to optimize the configuration of the radio coverage in the network, the set of radio cells contains the radio cell or cells in which network problems have been detected.

A radio cell is then selected from the several radio cells of the network in a step 22. This step is of benefit only if the set of radio cells contains more than one radio cell. In this situation, a radio cell is selected from the set of radio cells concerned and the remaining steps of the method are applied to it.

The radio cell to which the subsequent steps of the method are applied may be selected in an arbitrary order within the set of radio cells. Alternatively, successive radio cells to which the process is to be applied may be selected in a predetermined order, which may depend on the context in which the radio coverage configuration method is applied.

In particular, in the situation of optimizing the radio coverage configuration, the first-selected radio cell may be the cell that has an effective radio coverage farthest from the associated target radio coverage, for example.

Then, in a step 23, cellular information is obtained relating to the selected radio cell and its neighboring radio cells.

Such cellular information may consist of a spatial signature and a temporal signature.

Such information may be obtained during a network surveillance stage triggered by a user of the network and stored in the configuration entity 10.

Such information may equally be obtained from data received in real time during calls managed in the network. A transmission power value for a common channel of each cell may be obtained in this way.

It is equally possible to obtain such information from an approximation based on radio coverage predictions that are themselves obtained via design tools calling on propagation models.

The cellular information may consist of a temporal and spatial signature.

The cellular information may then also consist of a list of radio cells neighboring the radio cell concerned.

On the basis of the cellular information, it is possible in the steps 24, 25 to compare the effective radio coverages of the radio cells of the group of radio cells, which group consists of the selected radio cell and its neighboring radio cells, with the respective target radio coverages of the same radio cells.

Thereafter, if the effective radio coverage of at least one radio cell of this group is below its target radio coverage, new transmission power values are determined for each of the radio cells concerned of the group, i.e. for the selected cell and its neighboring radio cells.

Thus new effective radio coverages are set up and, because of this, a new radio coverage configuration of the network is set up.

The step 23 is then repeated to collect new cellular information relating to the selected cell and its neighboring cells, again in order to be able to compare the effective radio coverages of these cells with the respective target radio coverages associated with them.

Then, on repetition of the steps 24, 25, it is decided whether or not new transmission power values need to be determined.

Accordingly, as long as the overall effective radio coverage of the selected radio cell and its neighboring radio cells is not greater than or equal to the corresponding overall target radio coverage, i.e. all the respective target radio coverages associated with the neighboring cells and the selected cell, the steps 23 to 26 are repeated.

Then, when the above condition is satisfied, the respective transmission power values assigned to these cells are retained and applied.

If the set of radio cells to which a default transmission power value has been applied comprises a plurality of radio cells, the steps 23 to 26 are applied to each of the radio cells of that set.

Thus if, for the last cell selected in the step 22, it is found that the radio coverages of that radio cell and its neighboring radio cells are greater than or equal to the target radio coverage of the same cells, it is then verified, during a step 27, whether there remains another cell to be selected in the set of cells to which the transmission power default value has been applied.

If there remains in this set of radio cells a radio cell to which the method has not yet been applied, there follows the step 22, in order to execute the same steps as described above in relation to that last radio cell selected.

The successive selection of the radio cells within the set of radio cells may be effected in any order, there being no limitation of the present invention associated with this aspect.

Such a radio coverage configuration method may be triggered in different contexts, such as the context of planning the radio coverage of a network or the context of optimizing the radio coverage of a network.

Such a radio coverage configuration method thus comprises dynamic allocation of cellular transmission power. It makes it possible to increase the transmission power of the selected cell and/or to reduce the transmission power of its neighboring radio cells if that does not degrade the target radio coverage of the neighboring cells and if that provides a coherent corresponding relationship between the spatial signature of the new cell and those of its neighbors.

Comparison of the effective radio coverages and the target radio coverages is based on the temporal signature and on the spatial signature. To this end, it may be checked that the absolute power values (RSCP values) of a received signal and the signal-to-noise ratio values (Ec/No values) are greater than predetermined radio coverage threshold values at all points that form the spatial signature of the radio cell concerned and its neighboring radio cells. The values at these points may furthermore be weighted by the frequency of their involvement in the traffic of the last K calls.

Such a method may take account of a power protection margin expressed as a percentage, so that the calculated power does not correspond to 100% of the target radio coverage. This margin makes it possible to isolate the selected radio cell from its neighboring cells.

Then, before beginning to degrade the target coverages of the neighboring cells by reducing their transmission power, the position of the new cell may advantageously be changed. In this situation, it is then possible to degrade the radio coverage of the neighboring radio cells as a last resort.

If the method does not converge, even after changing the position of the radio cell, it must ensure that the target radio coverages of the new radio cell and its neighboring radio cells have the same power protection margin.

FIG. 3 shows the use of a radio coverage configuration method of one implementation of the present invention in the context of radio coverage planning.

Radio coverage planning is triggered in a step 31. It may be triggered on the detection of an event, for example introducing one or more new radio cells into the network, or when the communications network is first installed.

In a step 32, a set consisting of at least one radio cell is determined to which some steps of the configuration method of one implementation of the present invention may be applied. Here this set comprises all the radio cells newly introduced into the network, or all the radio cells in the context of installing the cellular network.

A radio cell in this set is then selected in a step 33. A group of radio cells is then defined to which a default transmission power value is applied. This group of radio cells includes the selected radio cell and its neighboring radio cells, i.e. cells that have a radio coverage geographical area neighboring that of the selected cell.

Then, in a step 34, the radio coverage configuration of the network is changed: a default transmission power value is applied to all the radio cells in this group.

Then, in a step 35, in order to determine the impact on the network of this change of radio coverage configuration, information relating to each cell of the group of radio cells is obtained.

This verification of the radio coverage may be based on various types of information that characterize a radio cell and relating to the temporal and spatial signatures and to the list of neighboring radio cells, as listed above.

Information relating to a power protection margin for characterizing a radio cell may also be taken into account here. Such a protection margin is generally expressed as a percentage of the target radio coverage and is applied to avoid interference with neighboring radio cells.

In one implementation of the present invention, information relating to the temporal signatures of the radio cells may then be used to decide whether the previously-assigned transmission power values are satisfactory or not.

On the basis of this cellular information, it is then possible to compare the effective cellular radio coverages of the radio cells of the group of cells concerned with the respective target radio coverages that are associated with them.

A radio coverage objective of such a radio coverage configuration method is to obtain a configuration in which the effective radio coverages of the radio cells of the group of radio cells concerned are greater than or equal to the target radio coverages of the cells of that group.

Accordingly, in a step 36, the radio coverages of the effective radio cells of the group of cells concerned are then compared with the target radio coverages of the cells of that group.

If the radio coverage objective is achieved, then the transmission power values of those cells are not modified further.

Otherwise, some transmission power values for some radio cells are modified as a function of the situations that may arise.

Thus, in a situation A, in a step 37, if the effective radio coverage of the new radio cell is less than the target radio coverage of that new cell the transmission power value of that new radio cell is increased.

In a situation B, in a step 38, if the effective radio coverage of the new radio cell is greater than the target radio coverage of that new cell the transmission power value of that new radio cell is reduced.

In a situation C, in a step 39, if the effective radio coverage of at least one of the neighboring cells of the new radio cell is less than its target radio coverage the transmission power value of that neighboring radio cell of the new radio cell is decreased.

In a situation D, in a step 40, if the effective radio coverage of at least one of the neighboring cells of the new radio cell is greater than its target radio coverage the transmission power value of that neighboring radio cell of the new radio cell is increased.

These contexts A, B, C, and D may be tested in an arbitrary order or in a predefined order.

Following each of the steps 37, 38, 39 or 40, the steps of the radio coverage configuration method are repeated, starting from the step 35.

To avoid repeating all the above steps many times without success, the number of repetitions may advantageously be limited to a maximum number N.

Under these circumstances, if after N repetitions of the step 35 all the effective radio coverages of the new cell and its neighboring cells are less than or equal to all the corresponding target radio coverages, this may be indicated on the base station, for example by an illuminated sign.

Such an illuminated sign then indicates that a change of position of the base station is required in order to be able to configure the overall radio coverage in one implementation of the present invention. Then, once such manual intervention has been effected at the base station, the configuration method of an implementation of the present invention may be triggered again starting from the step 34.

The reference 30 denotes the succession of steps 33-40.

The steps of a method of configuring the radio coverage of a cellular radio network may be executed in the context of optimizing the radio coverage.

The present invention is in no way limited by how such automatic optimization of the radio coverage configuration is triggered.

In this situation this method may in particular be triggered regularly and periodically.

The steps of such a method are shown in FIG. 4.

In a step 41, the radio coverage configuration method is triggered after a given time period or at a precise time.

In a step 42, the network is interrogated to decide whether network problems are present or not. To this end, information may be obtained relating to a cut-off rate, a quality of service level, or call traffic. This information may be collected for each cell in the network.

Accordingly, if some of this information indicates a network problem or problems, it is possible to identify a radio cell or a set of radio cells that is the source of the detected network problem or problems.

There is then a set consisting of at least one radio cell to which the radio coverage configuration method is to be applied.

The outcome of the step 42 in the context of radio coverage planning corresponds to the outcome of the step 32 in the context of radio coverage optimization.

The same succession of steps 30 as described with reference to FIG. 3 is advantageously applied here, in order to obtain an effective overall radio coverage in this set of radio cells that is greater than or equal to the corresponding target overall radio coverage.

Alternatively, in one implementation of the present invention, radio coverage configuration may be triggered on detecting a network problem. The configuration entity may be adapted to receive cellular information to enable such network problem detection.

For example, in one implementation of the present invention, automatic radio coverage configuration may be triggered on detection of a cut-off rate higher than a particular value. Radio coverage configuration may equally be triggered on detection of a quality of service level that is below a required quality of service level in the network concerned or if information relating to call traffic indicates a call traffic level lower than a threshold value.

Under these conditions, a radio coverage configuration method of one implementation of the present invention is then applied to a set of radio cells that have been detected as giving rise to problems, as described above.

FIG. 5 shows a radio coverage management entity of one embodiment of the present invention.

It may comprise:
a selection unit 51 adapted to select a radio cell from said particular set of radio cells;
a unit 52 adapted to obtain cellular information relating to a group of cells including the selected radio cell and neighboring cells;
a comparison unit 53 adapted, on the basis of the cellular information, to compare the effective radio coverages of the cells of said group and the respective target radio coverage of the cells of said group; and
a transmission power management unit 54 adapted:
   to apply (21) a given transmission power value to a set consisting of at least one particular radio cell from the plurality of radio cells; and
   to apply (26) new transmission power values to the respective radio cells of said group of cells if the effective radio coverage of at least one radio cell from said group of radio cells is less than the target radio coverage of said at least one radio cell of the group (25).

It may also further include a unit 55 for triggering radio coverage configuration on detection of a network problem and on introducing at least one new radio cell into the network.

Such a configuration entity 10 is adapted to implement overall planning and optimization of the network by a method as described above. It is therefore able to resolve some conflicts between different cells by making it possible to determine a compromise between the different radio coverages that could result from a transmission power assignment decision at the local level stemming from a process of assigning common channel power to the cells.

Such management of the configuration of the radio coverage in a network enables automatic and dynamic planning and optimization to be performed without any input from the operator or the end user. Here configuration is based on determining transmission power values on at least one common channel of the radio cells.

Such configuration management is in particular well suited to networks having a layer of cells that have a high density and restricted access and that are dedicated to use in a home or business framework (known as “femtocells”). Furthermore, such management is capable of dynamically solving problems of interference caused by uncoordinated deployment of plug-and-play cells and makes it possible to improve the overall quality of service of a network.

These features enable the operator to avoid devoting any effort to power planning or optimization that involves qualified personnel or the end user of the radio coverage. They enable these two types of configuration to be automated and interference problems caused by uncoordinated deployment of radio cells to be resolved dynamically. They also enable the overall quality of service of the network to be improved.

1. A method of configuring radio coverage in a cellular radio communications network comprising a plurality of radio cells, a target radio coverage being associated with each radio cell, and each operational radio cell providing an effective radio coverage defined by a transmission power value of said radio cell, said method comprising the following steps:
a) applying a given transmission power value to a particular set consisting of at least one radio cell from the plurality of radio cells;
b) selecting a radio cell from said particular set of radio cells;
c) obtaining cellular information relating to a group of radio cells comprising the selected radio cell and neighboring cells;
d) on the basis of the cellular information, comparing the effective radio coverages of the cells of said group and the respective target radio coverages of the cells of said group; and
e) if the effective radio coverage of at least one radio cell of said group of radio cells is less than the target radio coverage of said at least one radio cell of the group:
applying respective new transmission power values to the radio cells of said group of cells; and
repeating steps c) to e).

2. The radio coverage configuration method according to claim 1, wherein the new transmission power values are determined by comparing the effective radio coverages and the respective target radio coverages of the cells of the group of radio cells.

3. The radio coverage configuration method according to claim 1, wherein, in the step e), at least one of the following is performed:
1) if the effective radio coverage of the selected radio cell is less than, the target radio coverage of the selected radio cell, then the transmission power value of the selected radio cell is increased, and
2) if the effective radio coverage of at least one neighboring radio cell of the selected radio cell is less than the target radio coverage of said at least one neighboring radio cell, then the transmission power value of said at least one neighboring radio cell is increased.

4. The radio coverage configuration method according to claim 1, wherein the set consisting of at least one radio cell comprises at least one new radio cell introduced into the network or at least one radio cell of the network experiencing a network problem.

5. The radio coverage configuration method according to claim 1, wherein the steps of the method are triggered in at least one of the following ways:
periodically;
on detection of a network problem; and
on introduction of at least one new radio cell into the network.

6. The radio coverage configuration method according to claim 1, wherein the steps b) to e) are applied to each of the radio cells of the set comprising at least one radio cell.

7. The radio coverage configuration method according to claim 1, wherein the cellular information for a radio cell relates to a temporal signature of said radio cell, a spatial signature of said radio cell, and a list of neighboring radio cells of said radio cell.

8. An entity for configuring radio coverage in a cellular radio communications network comprising a plurality of radio cells, a target radio coverage being associated with each radio cell, and each operational radio cell providing an effective radio coverage defined by a transmission power value of said radio cell, said management entity comprising:
a selection unit adapted to select a radio cell from said particular set of radio cells;
a unit adapted to obtain cellular information relating to a group of cells comprising the selected radio cell and neighboring cells;
a comparison unit adapted, on the basis of the cellular information, to compare the effective radio coverage of the cells of said group and the respective target radio coverage of the cells of said group; and
a transmission power management unit adapted:
to apply a given transmission power value to a particular set consisting of at least one radio cell from the plurality of radio cells; and
to apply new transmission power values to the respective radio cells of said group of cells if the effective radio coverage of at least one radio cell of said group of radio cells is less than the target radio coverage of said at least one radio cell of the group.

9. A radio coverage configuration entity comprising a unit for triggering radio coverage configuration on detection of a network problem and on introducing at least one new radio cell into the network.

10. A computer program adapted to be installed in a configuration entity according to claim 8, comprising instructions adapted to execute a method when the program is executed by processing means of the management entity, the method comprising:
a) applying a given transmission power value to a particular set consisting of at least one radio cell from the plurality of radio cells;
b) selecting a radio cell from said particular set of radio cells;
c) obtaining cellular information relating to a group of radio cells comprising the selected radio cell and neighboring cells;
d) on the basis of the cellular information, comparing the effective radio coverages of the cells of said group and the respective target radio coverages of the cells of said group; and
e) if the effective radio coverage of at least one radio cell of said group of radio cells is less than the target radio coverage of said at least one radio cell of the group:
applying respective new transmission power values to the radio cells of said group of cells; and
repeating steps c) to e).

11. A computer-readable storage medium storing the computer program according to claim 10.

12. The radio coverage configuration method according to claim 1, wherein, in the step e), at least one of the following is performed:
1) if the effective radio coverage of the selected radio cell is greater than, the target radio coverage of the selected radio cell, then the transmission power value of the selected radio cell is decreased, and
2) if the effective radio coverage of at least one neighboring radio cell of the selected radio cell is greater than the target radio coverage of said at least one neighboring radio cell, then the transmission power value of said at least one neighboring radio cell is decreased.
